(19) United States
(12) Patent Application Publication
(10) Pub. No.: US 2012/0075851 A1
(43) Pub. Date: Mar. 29, 2012

(54) THREE-COLOR MIXING LED ILLUMINATING DEVICE

(75) Inventors: SHAO-HAN CHANG, Tu-Cheng (TW); XIAO-MAN PU, Shenzhen City (CN); FU-QIU SHI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/092,119

(22) Filed: Apr. 21, 2011

(30) Foreign Application Priority Data
Sep. 24, 2010 (CN) 201010289388.3

(51) Int. Cl. F21V 5/02

(52) U.S. Cl. 362/235

(57) ABSTRACT

An LED illuminating device comprises a housing with a base plate, a prism sheet and a circuit board. The prism sheet is mounted in the housing and comprises a number of V-shaped micro-grooves formed thereon along two directions intersecting with each other. A plurality of LED units are arranged in groups on the circuit board. Each LED illuminating group comprises three LED units. Each of the LED units emits light of a color different from those of the other two LED units. Four virtual mixed light sources are formed by the reflection of the prism sheet to the circuit board when the light emitted by a particular LED unit mixes with light emitted by adjacent LED units on the circuit board. Each of the virtual mixed light sources forms a desired color different from the colors of the light emitted from the LED units.

### CROSS-REFERENCES TO RELATED APPLICATIONS

Related subject matter is disclosed in a co-pending U.S. patent application with an Attorney Docket Number US36126 and a title of THREE-COLOR MIXING LED ILLUMINATING DEVICE, which has the same assignee as the current application and was concurrently filed.

### BACKGROUND

1. Technical Field

The present disclosure relates to light emitting diode (LED) illuminating devices, especially to a three-color mixing LED illuminating device.

2. Description of Related Art

Compared to many other kinds of illuminating devices, LED illuminating devices have many advantages, such as high luminous efficiency, low power consumption, and long service life. Even still, LED lights have disadvantages. The range of colors currently available for LEDs is limited. LEDs only come in a few basic colors, which cannot satisfy the needs of different users in particular applications.

Therefore, what is needed is an LED illuminating device that can overcome the above mentioned limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a cross-sectional view of an LED illuminating device according to an embodiment.

FIG. 2 is a partial isometric view of a prism sheet of the LED illuminating device of FIG. 1.

FIG. 3 is a schematic, planar view showing a plurality of virtual light sources formed an LED unit of the LED illuminating device.

FIG. 4 is a schematic, planar view showing the arrangement of the LED units array of the LED illuminating device.

FIG. 5 is a schematic, planar view showing a number of virtual mixing light sources formed by partial LED units of the LED illuminating device.

FIG. 6 is a schematic view of the virtual mixing light sources matrix formed by LED illuminating device.

### DETAILED DESCRIPTION

The disclosure, including the accompanying, is illustrated by way of example and not by way of limitation. It should be noted that references to “an” or “one” embodiment in this disclosure are not necessarily to the same embodiment, and such references mean at least one.

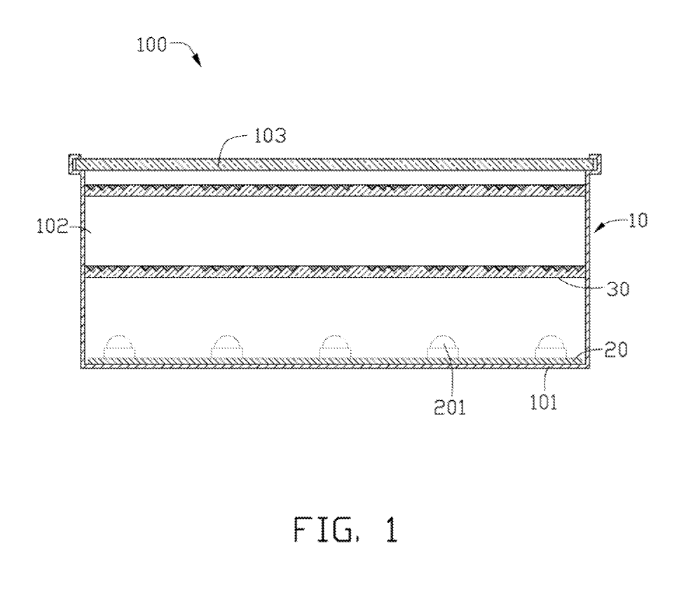

Referring to FIG. 1, a light emitting diode (LED) illuminating device 100 according to an embodiment is disclosed. The LED illuminating device 100 includes a housing 10, a circuit board 20, and a prism sheet 30. A number of LED units 201 are arranged on the circuit board 20. The housing 10 includes a base plate 101, a sidewall 102 surrounding the base plate 101, and a protection cover 103. The circuit board 20 is fixed on the base plate 101, and the prism sheet 30 is arranged above the circuit board 20 and substantially parallel to the circuit board 20. The protection cover 103 is fixed on the sidewall 102 and placed above the prism sheet 30 for protecting the prism sheet 30 and the circuit board 20 from being contaminated and damaged. In the embodiment, the protection cover 103 is made of transparent glass or transparent plastic plates. The base plate 101 and the sidewall 102 are made of metal or plastic having high reflectivity.

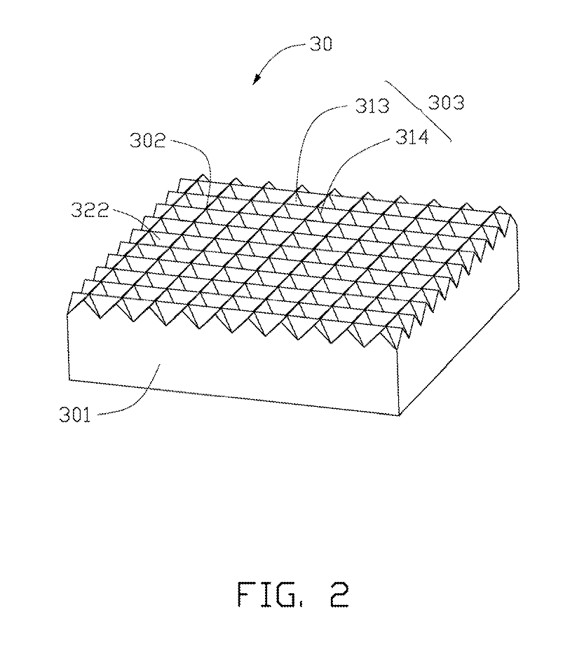

Referring to FIG. 2, the prism sheet 30 is made of transparent plastic and includes a light incident surface 301 and a light exit surface 302 opposite to the light incident surface 301. The light incident surface 301 is planar and faces the circuit board 20. A number of V-shaped micro-grooves 303 are formed on the light exit surface 302 along two directions. In the embodiment, an angle between two sides of each V-shaped micro-groove 303 is about 45 degrees. The V-shaped micro-grooves 303 include a first type of V-shaped micro-grooves 313 extending along a first direction X1, and a second type of V-shaped micro-grooves 314 extending along a second direction X2 substantially perpendicular to the first direction X1. The first type of V-shaped micro-grooves 313 are arranged in parallel rows, and the second type of V-shaped micro-grooves 314 are arranged in parallel columns The micro-groove rows intersect with the micro-groove columns to form a number of four-pointed stars 322 at the intersections.

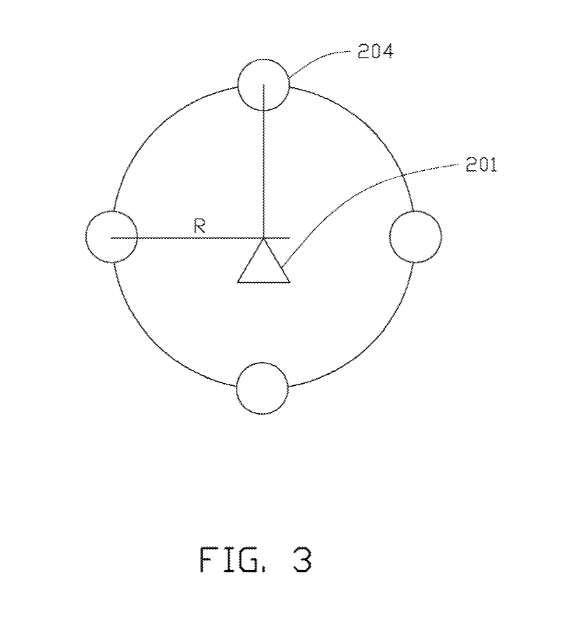

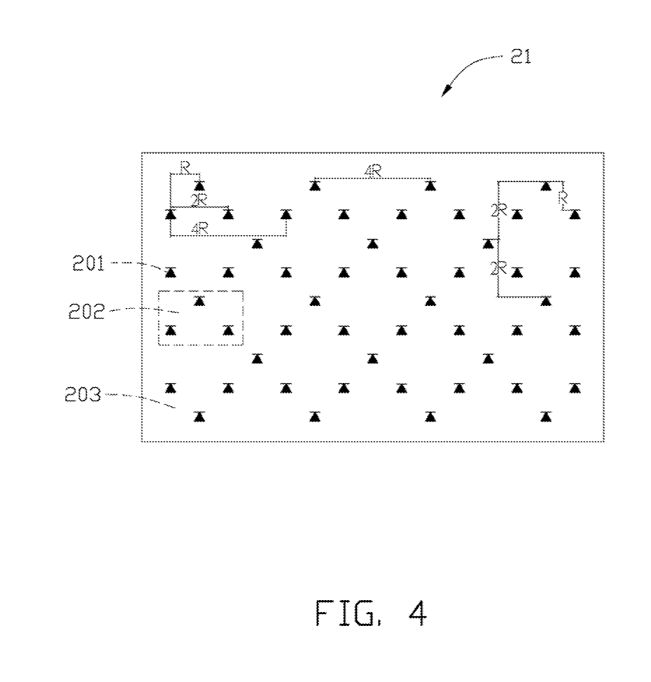

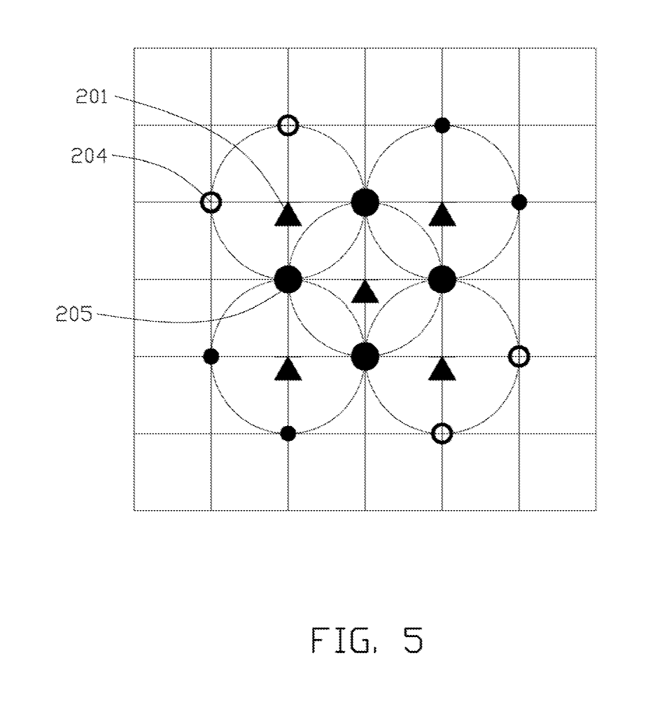

Referring to FIGS. 3-5, the LED units 201 are arranged in a matrix. The LED units 201 include a number of first LEDs emitting light of a first color, a number of second LEDs emitting light of a second color different from the first color. In addition, a number of third LEDs emitting light of a third color different from the first color and the second color. The LED units 201 are arranged in groups 202 are formed and each includes three LED units 201, i.e., a first LED, a second LED, and a third LED. The LED units 201 in a group 202 are arranged on three vertex of an isosceles triangle. Four virtual light sources 204 are reflected to the circuit board 20 by the four-pointed stars 322 of the prism sheet 30 when a particular LED unit 201 emits the light. The four virtual light sources 204 are generally distributed in a circle, which has a center aligned with the particular LED unit 201. The value of the radius R of the circle is influenced by the distance between the prism sheet 30 and the LED units 201. Four virtual mixed light sources 205 are formed on the circuit board 20 when the light emitted by an LED unit 201 mixes with light emitted by four adjacent LED units 201 on the circuit board 20. In the embodiment, the length of the bottom side of the isosceles triangle formed by an LED illuminating group 202 is 2R, and the high of the isosceles triangle is R. A number of groups 202 form an illuminating matrix 203. The row space and the column space of the illuminating matrix form 203 are defined to be R and 2R respectively. The one desired color different from the light emitted from each LED units can be selected for emission by the device 100 according to which three colors of LED units 201 are selected for mixing.

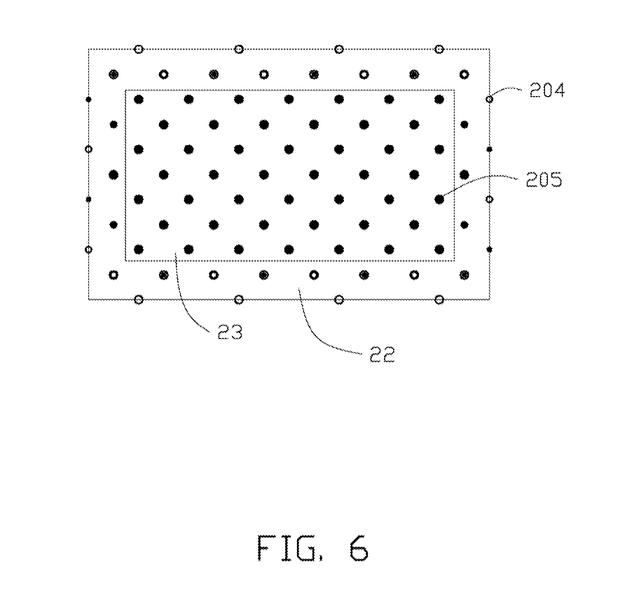

Referring to FIG. 6, a virtual light source matrix is formed. The virtual light source matrix includes a mixed light area 23 and a non-mixed light area 22 around the mixed light area 23.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An LED illuminating device comprising:
a housing comprising a base plate;
a prism sheet mounted in the housing and comprising a plurality of V-shaped micro-grooves formed thereon along two directions intersecting with each other;
a circuit board fixed on the base plate, wherein a plurality of LED units are arranged in groups on the circuit board, each LED illuminating group comprises three LED units, each of the LED units emits light of a color different from those of the other two LED units, four virtual mixed light sources are formed by reflection of the prism sheet to the circuit board when the light emitted by a particular LED unit mixes with light emitted by adjacent LED units on the circuit board, each of the virtual mixed light sources forms a desired color different from the colors of the light emitted from the LED units.

2. The LED illuminating device of claim 1, wherein the prism sheet comprises a light incident surface and a light exit surface opposite to the light incident surface; the light incident surface is planar and faces the circuit board; the plurality of V-shaped micro-grooves are formed on the light exit surface.

3. The LED illuminating device of claim 1, wherein the V-shaped micro-grooves comprise a plurality of a first type of V-shaped micro-grooves extending along a first direction, and a plurality of a second type of V-shaped micro-grooves extending along a second direction perpendicular to the first direction.

4. The LED illuminating device of claim 1, wherein the prism sheet is made of transparent plastic.

5. The LED illuminating device of claim 1, wherein the housing comprises a side wall extending around the base plate, the circuit board is fixed on the base plate, the prism sheet is arranged above the circuit board.

6. The LED illuminating device of claim 1, wherein the prism sheet is substantially parallel to the circuit board.

7. The LED illuminating device of claim 1, further comprising a protection cover, wherein the protection cover is fixed on the sidewall above the prism sheet for protecting the prism sheet and the circuit board from being contaminated and damaged.

8. The LED illuminating device of claim 1, wherein an angle between two sides of each V-shaped micro-groove is about 45 degrees.

9. The LED illuminating device of claim 5, wherein the base plate and the sidewall are made of metal or plastic having high reflectivity.

10. The LED illuminating device of claim 1, wherein the four virtual light sources are distributed on a circle which has a center aligned with the particular LED unit, the radius R of the circle is influenced by the distance between the prism sheet and the LED units.

11. The LED illuminating device of claim 10, wherein the LED units of each group are arranged on three vertexes of an isosceles triangle, and the length of the bottom side of the isosceles triangle is 2R, and the high of the isosceles triangle is \sqrt{2}R.
